(19) United States
(12) Patent Application Publication
(10) Pub. No.: US 2024/0047784 A1
(43) Pub. Date: Feb. 8, 2024

(54) BATTERY PACK AND VEHICLE

(71) Applicant: HONDA MOTOR CO., LTD., Tokyo (JP)

(72) Inventors: Yaozhong Huo, Guangzhou (CN); Yang Li, Guangzhou (CN); Jianhua Yu, Guangzhou (CN); Jian Li, Guangzhou (CN)

(21) Appl. No.: 18/227,339

(22) Filed: Jul. 28, 2023

(30) Foreign Application Priority Data
Aug. 4, 2022 (CN) 202210932003.3

(51) Int. Cl. H01M 10/6568; H01M 50/209; H01M 50/258; H01M 50/249; H01M 10/613; H01M 10/625; H01M 10/658; H01M 10/6556; H01M 10/6554; B60L 50/64

(52) U.S. Cl. CPC H01M 10/6568; H01M 50/209; H01M 50/258; H01M 50/249; H01M 10/613; H01M 10/625; H01M 10/658; H01M 10/6556; H01M 10/6554; B60L 50/64; H01M 2220/20

(57) ABSTRACT

A battery pack including: housing and battery provided in the housing; two or more heat exchange agent flow-paths for regulating temperature of the battery in the housing; the heat exchange agent flow-paths having heat-exchange-agent-inlet and heat-exchange-agent-outlet, the distance of the heat-exchange-agent-inlet from the center of the battery pack being greater than the distance of the heat-exchange-agent-outlet from the center of the battery pack; the heat exchange agent flow-paths further includes first-flow-section and second-flow-section; one end of the first-flow-section being in communication with the heat-exchange-agent-inlet; one end of the second-flow-section being in communication with the heat-exchange-agent-outlet; the other end of the first-flow-section being in communication with the other end of the second-flow-section; the distance between the first-flow-section and the center of the battery pack being greater than the distance between the second-flow-section and the center of the battery pack.

### CROSS-REFERENCE TO RELATED APPLICATION

Priority is claimed on Chinese Patent Application No. 202210932003.3, filed on Aug. 4, 2022, the contents of which are incorporated herein by reference.

### BACKGROUND OF THE INVENTION

### Field of the Invention

The present invention relates to a vehicle battery pack and vehicle.

### Description of Related Art

An onboard battery is used to provide the electrical energy needed to drive an electric vehicle. However, the performance of the battery in providing electrical energy for the electric vehicle is greatly affected by the temperature. If the temperature of the battery is too high, it may affect the life of the battery and may even cause a safety incident. If the temperature of the battery is too low, it will seriously affect the performance of the battery, which in turn will affect the driving range of the electric vehicle.

In order to enable the battery to operate in its proper temperature range, heat exchange pipes are usually placed around the battery. The heat exchange agent in the heat exchange pipes is used to exchange heat with the battery, so that the temperature of the battery can be regulated. However, regarding the temperature regulation effect, there is still potential for improvement in the prior art.

### SUMMARY OF THE INVENTION

This application provides a battery pack and vehicle that enhance a temperature regulation effect.

According to the first aspect of this application, provided is a battery pack comprising: a housing and a battery provided in the housing; two or more heat exchange agent flow-paths for regulating the temperature of the battery in the housing; the heat exchange agent flow-paths having a heat exchange agent inlet and a heat exchange agent outlet, the distance of the heat exchange agent inlet from the center of the battery pack being greater than the distance of the heat exchange agent outlet from the center of the battery pack; the heat exchange agent flow-paths further comprising a first flow section and a second flow section; one end of the first flow section being in communication with the heat exchange agent inlet; one end of the second flow section being in communication with the heat exchange agent outlet; the other end of the first flow section being in communication with the other end of the second flow section; the distance between the first flow section and the center of the battery pack being greater than the distance between the second flow section and the center of the battery pack.

From the above, by setting the heat exchange agent inlet farther than the heat exchange agent outlet from the center of the battery and setting the first flow section farther than the second flow section from the center of the battery, after the heat exchange agent enters the first flow section from the heat exchange agent inlet, it can first exchange heat with the outer part of the battery which is strongly affected by the ambient temperature; and after the heat exchange agent flows into the second flow section, it can then exchange heat with the middle part of the battery which is weakly affected by the ambient temperature. As a result, the temperature difference between different positions of the battery can be reduced and the temperature regulation effect can be enhanced.

As a possible embodiment of realizing the first aspect, if the height of the first flow section is defined as h1, then 2.1 mm h1 3.1 mm; and/or if the height of the second flow section is defined as h2, then 2.1 mm h2 3.1 mm.

From the above, a preferred range of heights of the first flow section and the second flow section is provided so that it is possible to reduce the weight of the heat exchange agent in the heat exchange agent flow-paths while also reducing the pressure loss of the heat exchange agent in the heat exchange agent flow-paths and obtaining a good heat exchange coefficient.

As a possible embodiment of realizing the first aspect, the first flow section and the second flow section each comprise at least two branches, with the at least two branches being spaced apart and arranged in parallel and communicating at the ends of each of the first flow section and the second flow section. From the above, by providing at least two branches in the first flow section and the second flow section in parallel, it is possible to adjust the temperature of the battery at the location where the temperature needs to be adjusted more precisely by each branch. Meanwhile, the first flow section and the second flow section can be divided into at least two branches by providing a structure such as a protrusion bar in the first flow section and the second flow section, and since the protrusion bar occupies a certain amount of space, the amount of heat exchange agent that can be accommodated in the first flow section and the second flow section can be reduced and the weight of the vehicle can be reduced.

As a possible embodiment of realizing the first aspect, the branches in the first flow section are of the same width; and/or the branches in the second flow section are of the same width.

From the above, it is possible to make the pressure loss of the heat exchange agent more uniform between different branches by setting the widths between the different branches to be the same, thus avoiding the pressure loss of the heat exchange agent in the heat exchange agent flow-paths to be increased due to the excessive pressure loss in one branch. Meanwhile, setting the width between the branches to be the same can also make the flow rate of the heat exchange agent in each branch more uniform, which in turn will cause a more uniform rate of regulation of the battery temperature and enhance the temperature regulation effect.

As a possible embodiment of realizing the first aspect, a mounting position is provided between two branches; and the branches are provided with a deflecting bend that is arc-shaped to avoid the mounting position.

From the above, when there is a mounting position between the branches, it is possible to allow the branches to avoid the mounting position by providing a deflecting bend in the branches. As a result, the influence between the branches and the mounting position can be reduced.

As a possible embodiment of realizing the first aspect, the farther a branch is located from the mounting position, the smaller the curvature of the deflecting bend in the branch is.

From the above, by setting the curvature of the deflecting bend in the branch farther away from the mounting position to be smaller, it is possible to make the width of the deflecting bend in different branches more uniform, and thus make the pressure loss of the heat exchange agent more uniform between different branches to enhance the temperature regulation effect. Meanwhile, it is also possible to reduce the width change of the branch in the deflecting bend, so as to reduce the pressure loss of the heat exchange agent in the branch.

As a possible embodiment of realizing the first aspect, the heat exchange agent inlet is located further up than the first flow section; and/or the heat exchange agent outlet is located further up than the second flow section.

From the above, by setting the heat exchange agent inlet above the first flow section and the heat exchange agent outlet above the second flow section, it is possible to avoid collisions between the heat exchange agent inlet and outlet and the pipes connected to them and objects appearing below the housing, reducing the chance of leakage due to collisions. As a result, the protective structure for the heat exchange agent inlet and outlet can be reduced and the structural strength of the housing can be enhanced.

As a possible embodiment of realizing the first aspect, the heat exchange agent flow-paths further comprise: an inflow cavity communicating one end of the first flow section with the heat exchange agent inlet, the inflow cavity having a cross-sectional area in the horizontal direction gradually increasing from top to bottom.

From the above, by setting the cross-sectional area of the inflow cavity in the horizontal direction to gradually increase from top to bottom, the heat exchange agent flowing in the inflow cavity is guided so that the heat exchange agent flows in a diffuse manner in the inflow cavity toward each branch. As a result, the pressure loss of the heat exchange agent in the inflow cavity is reduced, the flow of the heat exchange agent is facilitated, and the temperature regulation effect is enhanced.

As a possible embodiment of realizing the first aspect, the heat exchange agent flow-paths further comprise: an outflow cavity communicating one end of the second flow section with the heat exchange agent outlet, the outflow cavity having a cross-sectional area in the horizontal direction decreasing from bottom to top.

From the above, by setting the cross-sectional area of the outflow cavity in the horizontal direction to gradually decrease from bottom to top, the heat exchange agent flowing in the outflow cavity is guided so that the heat exchange agent gradually converges as it flows in the outflow cavity toward the heat exchange agent outlet to allow the heat exchange agent to be discharged from the heat exchange agent outlet. As a result, the pressure loss of the heat exchange agent in the outflow cavity is reduced, the flow of the heat exchange agent is facilitated, and the temperature regulation effect is enhanced.

As a possible embodiment of realizing the first aspect, the heat exchange agent flow-paths further comprise: a fluxion cavity communicating the other end of the first flow section to the other end of the second flow section.

From the above, the heat exchange agent in the plurality of branches of the first flow section can converge in the fluxion cavity and be delivered by the fluxion cavity to the plurality of branches in the second flow section. As a result, the pressure loss caused by the transfer of the heat exchange agent from the first flow section into the second flow section by dividing it into at least two branches for delivery can be reduced, and thus the temperature regulation effect can be enhanced.

As a possible embodiment of realizing the first aspect, the fluxion cavity is provided with an inferior arc cross-sectional shape in the horizontal direction on a side away from the first flow section and the second flow section.

From the above, by setting the fluxion cavity in an inferior arc shape, the heat exchange agent in the fluxion cavity can be guided, thus reducing the pressure loss of the heat exchange agent in the fluxion cavity. Accumulation of some heat exchange agent in the fluxion cavity that cannot participate in the regulation of the battery temperature can also be avoided, thus enhancing the temperature regulation efficiency of the heat exchange agent. In addition, the inferior arc-shaped fluxion cavity can reduce the volume of the fluxion cavity compared with the semi-circular or major arc-shaped fluxion cavity, which can make the housing more compact.

As a possible embodiment of realizing the first aspect, the fluxion cavity is provided with a trapezoidal cross-sectional shape in the horizontal direction, with the bottom edge of the trapezoid provided on a side close to the first flow section and the second flow section and the top edge of the trapezoid away from the first flow section and the second flow section.

Since the length of the top edge of the trapezoid is smaller than the length of the bottom edge, by setting the cross-sectional shape of the fluxion cavity in the horizontal direction to a trapezoid, it is possible to make the coolant in the first flow section enter the fluxion cavity from the bottom edge of the trapezoid near one side, and then the coolant can flow into the second flow section from the bottom edge of the trapezoid near the other side under the guidance of both sides of the trapezoid and the top edge. As a result, the pressure loss of coolant in the fluxion cavity can be reduced and some of the heat exchange agent can be prevented from stagnating in the fluxion cavity. At the same time, the trapezoidal structure can achieve the same effect of reducing the volume of the fluxion cavity and making the housing structure more compact compared with a cavity of a semi-circular structure or a major arc structure.

As a possible embodiment of realizing the first aspect, a U-shaped structure is formed by the first flow section, the second flow section and the fluxion cavity together.

From the above, by forming a U-shaped structure with the first flow section, the second flow section and the fluxion cavity, the U-shaped path structure can reduce the number of turns of the heat exchange agent compared with an existing S-shaped path, which in turn can reduce the pressure loss of the heat exchange agent and enhance the temperature regulation effect.

As a possible embodiment of realizing the first aspect, the housing comprises a lower housing and a base plate, with the base plate mounted on the lower housing, and the heat exchange agent flow-paths formed between the base plate and the lower housing.

From the above, the heat exchange agent flow-paths are formed between the base plate and the lower housing, so that components such as a heat exchange agent tube for the flowing of the heat exchange agent can be dispensed with independently. As a result, the structure of the housing can be simplified, the weight of the housing can be reduced, and light weight can be achieved. Meanwhile, it is possible to reduce the number of parts of the housing, reduce assembly steps and assembly time, and improve assembly efficiency.

As a possible embodiment of realizing the first aspect, the battery comprises at least two battery modules, the battery modules comprising at least two battery cores; the base plate is provided with at least two bumps protruding towards the lower housing; and the bumps are positioned in one-to-one correspondence with the battery cores.

From the above, the structural strength of the base plate can be enhanced by providing bumps on the base plate. As a result, the thickness and weight of the base plate can be reduced while meeting the strength requirements of the base plate, and the weight of the housing can be reduced to achieve light weight. In addition, when a milling cutter is required to process the surface of the base plate towards the battery cores, only the top surfaces of the bumps need to be processed, thus reducing the workload of milling cutter processing and increasing the processing speed.

As a possible embodiment of realizing the first aspect, the first flow section and the second flow section both extend along the length of the battery cores.

Since the length of the battery cores is larger than the width, under the condition that the first flow section and the second flow section have the same contact area with the battery cores, compared with the way that the first flow section and the second flow section extend in the width direction of the vehicle in such a way that the first flow section and the second flow section extend in the length direction of the vehicle, the length and width of the first flow section and the second flow section are smaller at the turning position when the first flow section and the second flow section extend in the length direction of the vehicle. As a result, the capacity of the heat exchange agent in the turning position of the first flow section and the second flow section can be reduced, and thus the weight of the battery pack and the vehicle can be reduced and light weight can be achieved.

As a possible embodiment of realizing the first aspect, the lower housing is connected to the battery module by means of a heat transfer adhesive.

From the above, it is possible to enhance the heat exchange between the lower housing and the battery module by providing a heat transfer adhesive between the lower housing and the battery module, thus improving the temperature regulation effect.

As a possible embodiment of realizing the first aspect, a heat insulation layer is further provided on the side of the base plate away from the lower housing.

From the above, by providing a heat insulation layer on the base plate, it is possible to reduce the influence of ambient temperature on the housing and the battery inside the housing.

As a possible embodiment of realizing the second aspect, a vehicle comprises a bodywork provided with a battery pack therein. The battery pack is any of the possible implementations of the battery pack in the first aspect of this application.

From the above, the battery pack in the first aspect is mounted in the vehicle, and by setting the heat exchange agent inlet farther away from the center of the battery than the heat exchange agent outlet, and setting the first flow section farther away from the center of the battery than the second flow section, after the heat exchange agent enters the first flow section from the heat exchange agent inlet, it can first exchange heat with the outer part of the battery which is greatly affected by the ambient temperature; and after the heat exchange agent flows into the second flow section, it can then exchange heat with the middle part of the battery which is less affected by the ambient temperature. As a result, the temperature difference between different locations of the battery can be reduced and the temperature regulation effect can be improved.

As a possible embodiment of realizing the second aspect, the first flow section and the second flow section both extend along the length of the vehicle.

From the above, it is possible to make the first flow section and the second flow section extend in the same direction as the length direction of the battery cores when, for example, the length direction of the battery cores in the battery pack is the same as the length direction of the vehicle. Since the length of the battery cores is larger than the width, under the condition that the first flow section and the second flow section have the same contact area with the battery cores, compared with the first flow section and the second flow section extending in the width direction of the vehicle in such a way that he first flow section and the second flow section extend in the length direction of the vehicle, the length and width of the first flow section and the second flow section are smaller at the turning position when the first flow section and the second flow section extend in the length direction of the vehicle. As a result, the capacity of the heat exchange agent in the turning position of the first flow section and the second flow section can be reduced, and thus the weight of the battery pack and the vehicle can be reduced and light weight can be achieved.

These and other aspects of the present invention will be more succinctly understood in the description of the (plural) embodiment(s) below.

### BRIEF DESCRIPTION OF THE DRAWINGS

The various features of the present invention and the relationships between the various features are further described below with reference to the accompanying drawings. The accompanying drawings are exemplary, some features are not shown to actual scale, and some of the accompanying drawings may omit features that are common to the field related to the present application and are not essential to the present application, or additionally show features that are not essential to the present application, and the combination of features shown in the accompanying drawings is not intended to limit the present application. In addition, the same reference symbols of the accompanying drawings are the same throughout the specification. The specific accompanying drawings are illustrated as follows:

FIG. 1 is a schematic diagram of one use scenario of the housing of a battery pack for a vehicle in an embodiment of the present application;

FIG. 2 is a schematic diagram of the structure of a battery pack in an embodiment of the present application;

FIG. 3 is a schematic diagram of the structure of the housing in FIG. 2;

FIG. 4 is a schematic diagram of the heat exchange coefficient, pressure loss, and weight of the heat exchange agent in the heat exchange agent flow-paths in FIG. 3 as a function of the height of the heat exchange agent flow-paths;

FIG. 5 is a schematic diagram of the side structure of the housing in FIG. 3;

FIG. 6 is a schematic diagram for illustrating the shape of the heat exchange agent flow-paths;

FIG. 7 is a schematic diagram of the fluxion cavity in an embodiment of the present application compared with other shapes of the fluxion cavity;

FIG. 8 is a schematic diagram of the structure of the battery module in FIG. 2;

FIG. 9 is a comparison diagram of heat exchange agent flow-paths extending in the length and width directions of the battery cores;

FIG. 10 is a schematic diagram of a comparative example of the flow direction of a heat exchange agent;

FIG. 11 is a schematic partial cross-sectional diagram of the housing in the vertical plane at the position of the heat exchange agent inlet and the heat exchange agent outlet in this application embodiment;

FIG. 12 is a schematic diagram of the structure of the battery pack in an embodiment of the present application;

FIG. 13 is a schematic diagram of the structure of the housing in FIG. 12;

FIG. 14 is a disassembled schematic view of the housing in FIG. 12;

FIG. 15 is a schematic diagram of the structure of the lower housing in FIG. 14;

FIG. 16 is a schematic diagram of the structure of the base plate in FIG. 14;

FIG. 17 is a radial sectional view of the heat exchange agent inlet and the heat exchange agent outlet in FIG. 13;

FIG. 18 is a schematic partial enlarged view of the inflow and outflow cavities in FIG. 13;

FIG. 19 is a partial cross-sectional enlarged view of the battery pack in FIG. 12 at the corresponding position of the battery cores.

### BRIEF DESCRIPTION OF THE REFERENCE SYMBOLS

1 vehicle; 10 battery pack; 20 bodywork; 30 wheel; 100 housing; 110 heat exchange agent flow-path; 111 heat exchange agent inlet; 112 heat exchange agent outlet; 113 first flow section; 114 second flow section; 115 branch; 115a concave part; 116 inflow cavity; 117 outflow cavity; 118 fluxion cavity; 119 deflecting bend; 120 first mounting position; 130 lower housing; 131 protrusion bar; 132 mounting part; 140 base plate; 141 bump; 142 second mounting position; 200 battery; 210 battery module; 211 battery core.

### DETAILED DESCRIPTION OF THE INVENTION

The terms “first, second, third, etc.” or similar terms such as Module A, Module B, Module C, etc. are used herein only to distinguish similar objects and do not imply a particular ordering of objects, and it is understood that particular orders or sequences may be interchanged where permitted so that embodiments of the present application described herein can be implemented in an order other than that illustrated or described herein.

The term “including” as used herein should not be construed as limiting to what is listed thereafter, and it does not exclude other components. Accordingly, it should be interpreted as designating the presence of the described feature, entity or component mentioned, but does not exclude the presence or addition of one or more other features, entities or components and groups thereof. Thus, the expression “unit comprising parts A and B” should not be limited to a unit comprising only parts A and B.

References in this specification to “an embodiment” or “embodiments” mean that the particular feature, structure or characteristics described in conjunction with that embodiment are included in at least one embodiment of the present invention. Thus, the terms “in an embodiment” or “in embodiments” appearing throughout this specification do not necessarily refer to the same embodiment, but may refer to the same embodiment. In addition, in one or more embodiments, the particular features, structures, or characteristics can be combined in any suitable manner, as would be apparent from the present disclosure to one skilled in the art.

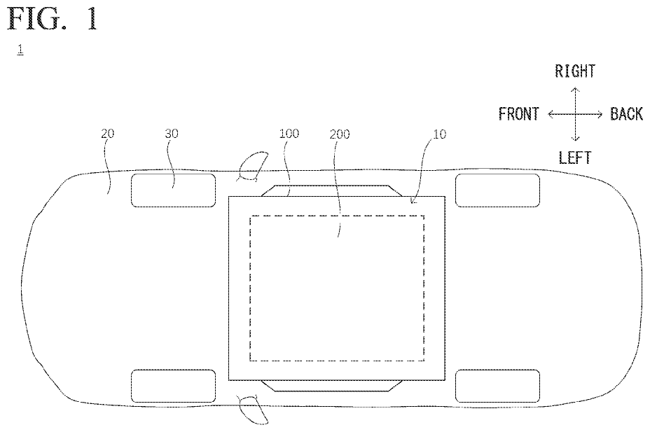

FIG. 1 is a schematic diagram of one use scenario of the housing 100 of a battery pack 10 for a vehicle 1 in an embodiment of the present application. FIG. 1 and the vehicle 1 herein are illustrative examples of electric vehicles and should not be considered as limitations of this application. The vehicle 1 can be an electric or hybrid vehicle, or any of the different types of vehicles such as a car, a truck, a passenger bus, or a sport utility vehicle (SUV). The vehicle 1 can also be a tricycle, a two-wheeled vehicle, a train or other land transportation means for carrying people or cargo.

As shown in FIG. 1, the vehicle 1 in this application includes a bodywork 20, wheels 30, and a battery pack 10, among other items. The wheels 30 are provided at the underside of the bodywork 20, and the wheels 30 rotate so as to move the vehicle 1. The battery pack 10 is provided in the bodywork 20, specifically, in the middle of the underside of the bodywork 20, or at any other suitable location. The battery pack 10 includes a housing 100 and a battery 200, the battery 200 being mounted in the housing 100 and providing the electrical energy required by the vehicle 1.

Hereinafter, the specific structure of the battery pack 10 in this embodiment of the application will be described in detail in conjunction with the accompanying drawings.

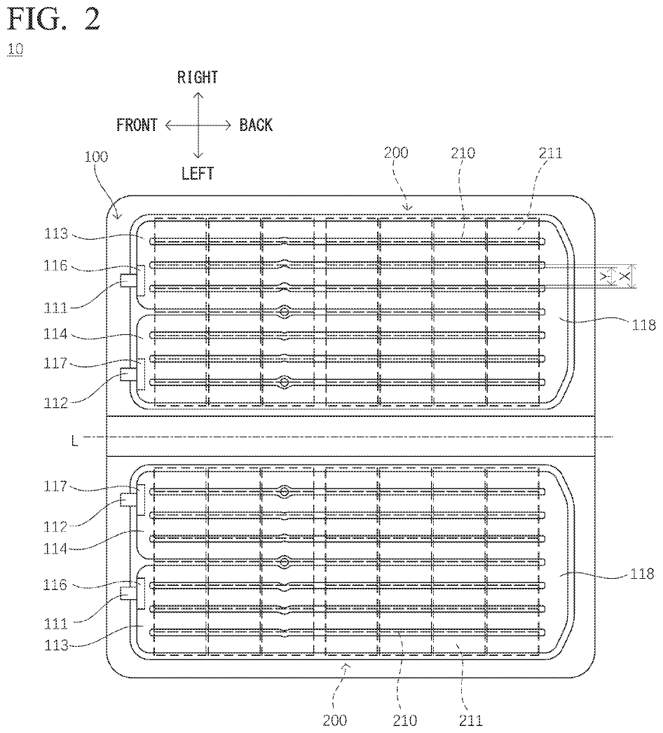

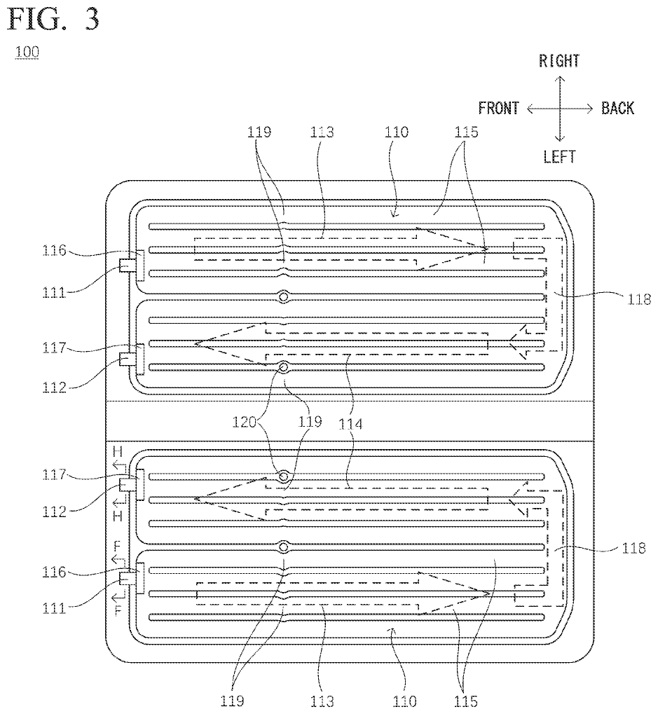

FIG. 2 is a schematic diagram of the structure of a battery pack in an embodiment of the present application. FIG. 3 is a schematic diagram of the structure of the housing in FIG. 2. As shown in FIGS. 2 and 3, the battery pack 10 in this embodiment of the application includes a housing 100 and a battery 200 provided in the housing 100, wherein the housing 100 is provided with two or more heat exchange agent flow-paths 110 for regulating the temperature of the battery 200, and the heat exchange agent flow-paths 110 include a heat exchange agent inlet 111 and a heat exchange agent outlet 112, with the distance between the heat exchange agent inlet 111 and the center of the battery pack 10 being greater than the distance between the heat exchange agent outlet 112 and the center of the battery pack The center of the battery pack 10 may be on a centerline L extending in a front-back direction as shown in FIG. 2, for example. Alternatively, in other embodiments, where the battery pack 10 is rectangular in shape, for example, the center of the battery pack 10 may also be the intersection of diagonal lines of the battery pack 10.

The heat exchange agent flow-paths 110 also include a first flow section 113 and a second flow section 114, one end of the first flow section 113 is communicated with the heat exchange agent inlet 111, one end of the second flow section 114 is communicated with the heat exchange agent outlet 112, the other end of the first flow section 113 is communicated with the other end of the second flow section 114, and the distance between the first flow section 113 and the center of the battery pack 10 is greater than the distance between the second flow section 114 and the center of the battery pack 10.

From this, by setting the heat exchange agent inlet 111 farther than the heat exchange agent outlet 112 from the center of the battery 200 and setting the first flow section 113 farther than the second flow section 114 from the center of the battery 200, after the heat exchange agent enters the first flow section 113 from the heat exchange agent inlet 111, it can first perform heat exchange with the outer part of the battery 200 which is strongly affected by the ambient temperature; and after the heat exchange agent flows into the second flow section 114, it can then perform heat exchange with the middle part of the battery 200 which is weakly affected by the ambient temperature. As a result, the temperature difference between different positions of the battery 200 can be reduced and the temperature regulation effect can be enhanced.

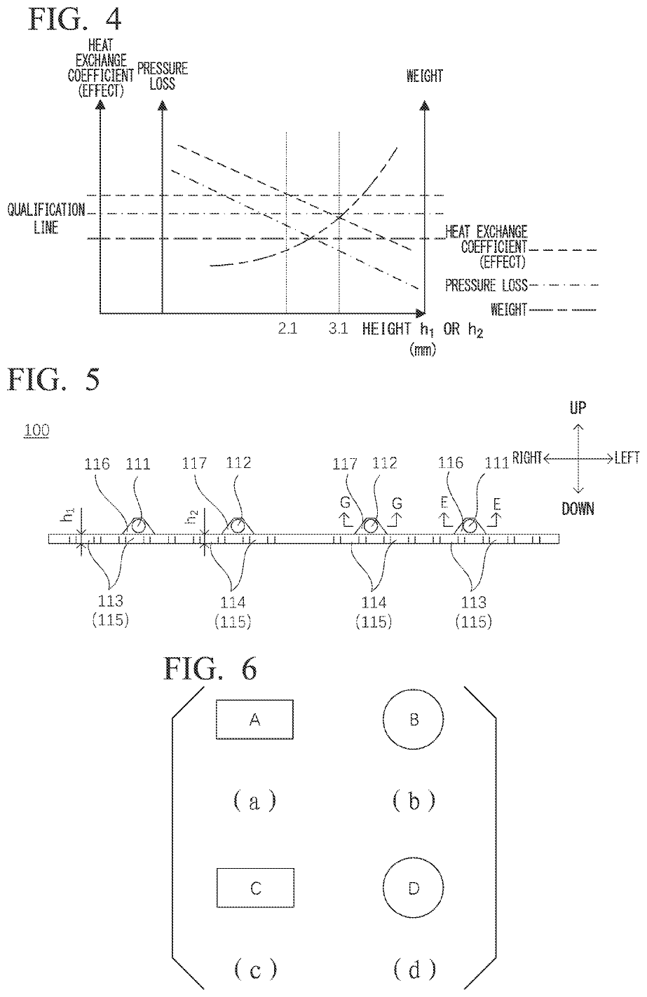

FIG. 4 shows the heat exchange coefficient, pressure loss and weight of the heat exchange agent in the heat exchange agent flow-paths 110 in FIG. 3 as a function of the height of the heat exchange agent flow-paths 110; FIG. 5 is a schematic diagram of the side structure of the housing 100 in FIG. 3, with the height of the first flow section 113 and the second flow section 114 marked. As shown in FIGS. 4 and 5, in some embodiments, the height of the first flow section 113 can be defined as h1 and the height of the second flow section 114 can be defined as h2. In the situation where the flow rate of the heat exchange agent in the heat exchange agent flow-paths 110 remains constant, the heat exchange coefficient (effect), pressure loss and weight of the heat exchange agent in the first flow section 113 and the second flow section 114 change accordingly with the increase of the height h1 of the first flow section 113 and the height h2 of the second flow section.

Specifically, as the height h1 of the first flow section 113 increases, the volume of the heat exchange agent in the first flow section 113 increases. Accordingly, the weight of the heat exchange agent held in the first flow section 113 also increases. Similarly, as the height h2 of the second flow section 114 increases, the weight of the heat exchange agent held in the second flow section 114 also increases.

As the height h1 of the first flow section 113 increases, it causes the size of the cross section perpendicular to the flowing direction of the heat exchange agent in the first flow section 113 to increase. Since the flow volume of the heat exchange agent remains the same, it causes the flow rate of the heat exchange agent to decrease. The faster the flow rate of the heat exchange agent is, the faster the heat exchange speed between the heat exchange agent and the battery 200 is, i.e., the larger the heat exchange coefficient of the heat exchange agent is, the better the heat exchange effect is. Therefore, as the height h1 of the first flow section 113 increases, the heat exchange coefficient of the heat exchange agent in the first flow section 113 decreases. Similarly, as the height h2 of the second flow section 114 increases, the heat exchange coefficient of the heat exchange agent in the second flow section 114 also decreases gradually.

As the height h1 of the first flow section 113 increases, the size of the cross section perpendicular to the flowing direction of the heat exchange agent in the first flow section 113 is increased. As a result, the heat exchange agent can flow more easily in the first flow section 113, so that the pressure loss of the heat exchange agent in the first flow section 113 is reduced. Similarly, as the height h2 of the second flow section 114 increases, the pressure loss of the heat exchange agent in the second flow section 114 also decreases.

FIG. 4 also shows qualification lines of the heat exchange coefficient (effect), pressure loss and weight of the heat exchange agent. As shown in FIG. 4, according to the qualification lines of the heat exchange coefficient (effect), pressure loss and weight of heat exchange agent, combined with the influence of the heights h1 and h2 on the heat exchange coefficient (effect), pressure loss and weight of heat exchange agent, it is known that when the height h1 of the first flow section 113 and the height h2 of the second flow section 114 are less than 2.1 mm, although the heat exchange coefficient of heat exchange agent is large and the heat exchange effect is good, the pressure loss of the heat exchange agent is large, which is too high of a demand on the pump driving the heat exchange agent to flow, and will increase the difficulty of selecting the pump and increase the production cost of the vehicle. When the height h1 of the first flow section 113 and the height h2 of the second flow section 114 are greater than 31 mm, although the pressure loss of the heat exchange agent can be reduced, it will also cause the weight of the heat exchange agent to be too large, which will increase the energy consumption of the vehicle and affect the driving range of the vehicle. Meanwhile, it will also make the heat exchange coefficient of the heat exchange agent too small and the heat exchange effect poor. Therefore, preferably, the height h1 of the first flow section 113 and the height h2 of the second flow section 114 can be set to within 2.1 mm to 3.1 mm. Thus, it is possible to reduce the weight of the heat exchange agent in the heat exchange agent flow-paths 110 while reducing the pressure loss of the heat exchange agent in the heat exchange agent flow-paths 110, and obtain a good heat exchange coefficient.

As shown in FIG. 3, the first flow section 113 and the second flow section 114 each include at least two branches 115 spaced apart and arranged in parallel, so that the temperature of battery cores 211 of the battery 200 can be adjusted more precisely by arranging the branches 115 in a position to correspond one to one with the arrangement of the battery cores 211. In addition, by providing at least two branches 115 in each of the first flow section 113 and the second flow section 114, the amount of heat exchange agent that can be accommodated in the first flow section 113 and the second flow section 114 can be reduced. Specifically, for example, in the following embodiment, the first flow section 113 and the second flow section 114 are divided into at least two branches 115 by providing protrusion bars 131 in the first flow section 113 and the second flow section 114, thereby reducing the amount of heat exchange agent that can be accommodated in the first flow section 113 and the second flow section 114 due to the space occupied by the protrusion bars 131 in the first flow section 113 and the second flow section 114. Meanwhile, since the width of the branches 115 does not need to be as long as the width of the battery cores 211 and there may be a gap between two adjacent battery cores 211, it is possible to reduce the inflow of the heat exchange agent and reduce the weight of the battery pack while satisfying the heat exchange effect by providing the following protrusion bars 131 in the first flow section 113 and the second flow section 114.

As shown in FIG. 3, the widths of the branches 115 in the first flow section 113 are the same; and/or the widths of the branches 115 in the second flow section 114 are the same. As a result, the pressure loss of the heat exchange agent between the different branches 115 can be made more uniform, and the pressure loss of the heat exchange agent in the heat exchange agent flow-paths 110 can be increased due to the excessive pressure loss of one branch 115. Meanwhile, it is also possible to make the flow rate of the heat exchange agent in each branch 115 more uniform by setting the widths of the branches 115 to be the same, which in turn makes the temperature regulation rate of the battery 200 more uniform and improves the temperature regulation effect.

As shown in FIG. 3, the housing 100 in this embodiment of the present application also includes a first mounting position 120, which can be a mounting hole, a positioning hole, a positioning post or another structure, and the first mounting position 120 is provided between two branches 115. Specifically, as shown in FIG. 3, there can be a plurality of first mounting positions 120, and the plurality of first mounting positions 120 can be arranged along the width of the housing 100 and can be provided between only some of the branches 115, depending on the needs of the structure. The branches 115 are provided with a deflecting bend 119 bending to the left or right to avoid the first mounting position 120.

Thus, when the first mounting position 120 exists between the branches 115, it is possible for the branches 115 to avoid the first mounting position 120 by providing a deflecting bend 119 in the branches 115. As a result, the influence between the branches 115 and the first mounting position 120 can be reduced.

As shown in FIG. 3, the farther away from the first mounting position 120 a branch 115 is, the smaller the curvature of the deflecting bend 119 on the branch 115 is.

Accordingly, the width of the branch 115 at the deflecting bend 119 is approximately the same as the width of the other parts, thereby making the flow rate of the heat exchange agent in the branch 115 uniform and the temperature regulation effect uniform. Further, the pressure loss of the heat exchange agent is made more uniform between the different branches 115 to improve the temperature regulation effect.

FIG. 5 also shows the location and shape of the first flow section 113, the second flow section 114, the heat exchange agent inlet 111 and the heat exchange agent outlet 112 from the side of the housing 100. As shown in FIG. 5, the heat exchange agent inlet 111 is located further up than the first flow section 113; and/or the heat exchange agent outlet 112 is located further up than the second flow section 114. As a result, it is possible to avoid collisions between the heat exchange agent inlet 111 and the heat exchange agent outlet 112 as well as the connected pipes and other parts with objects below the housing 100, reducing the chance of leakage due to collisions. As a result, the structure of the housing 100 can be simplified and the weight of the housing 100 can be reduced by eliminating the need for a protective structure for the heat exchange agent inlet 111 and the heat exchange agent outlet 112.

As shown in FIG. 5, the heat exchange agent flow-paths 110 in this embodiment of the application also include an inflow cavity 116 communicating one end of the first flow section 113 with the heat exchange agent inlet 111. The inflow cavity 116 has a trapezoidal shape when viewed from the side, and the cross-sectional area of the inflow cavity 116 in the horizontal direction gradually increases from top to bottom. Thus, the heat exchange agent flowing in the inflow cavity 116 can be guided so that the heat exchange agent flows in a diffuse manner in the inflow cavity 116 towards each branch 115. As a result, the pressure loss of the heat exchange agent in the inflow cavity 116 can be reduced, and the flowing of the heat exchange agent can be facilitated to improve the temperature regulation effect.

As shown in FIG. 5, the heat exchange agent flow-paths 110 in this embodiment of the application also include an outflow cavity 117 communicating one end of the second flow section 114 with the heat exchange agent outlet 112. The outflow cavity 117 has a trapezoidal shape when viewed from the side, and the cross-sectional area of the outflow cavity 117 in the horizontal direction decreases from bottom to top. Thus, the heat exchange agent flowing in the outflow cavity 117 can be guided so that the heat exchange agent gradually converges in the outflow cavity 117 as it flows toward the heat exchange agent outlet 112 so that the heat exchange agent is discharged from the heat exchange agent outlet 112. As a result, the pressure loss of the heat exchange agent in the inflow cavity 116 is reduced, and the flow of the heat exchange agent is facilitated to improve the temperature regulation effect.

FIG. 6 shows a schematic diagram to illustrate the shape of the heat exchange agent flow-paths 110. (a) in FIG. 6 shows a cross-sectional view of the inflow cavity 116 in the E-E direction in FIG. 5, (b) in FIG. 6 shows a cross-sectional view of the heat exchange agent inlet 111 in the F-F direction in FIG. 3, (c) in FIG. 6 shows a cross-sectional view of the outflow cavity 117 in the G-G direction in FIG. 5, and (d) in FIG. 6 shows a cross-sectional view of the heat exchange agent outlet 112 in the H-H direction in FIG. 3.

(a) in FIG. 6 shows a horizontal cross-section on the inflow cavity 116 in communication with the heat exchange agent inlet 111, with its area defined as A. (b) in FIG. 6 shows a cross-section of the heat exchange agent inlet 111, with its area defined as B. The location on the inflow cavity 116 in communication with the heat exchange agent inlet 111 can be specifically the center of the vertical cross-section of the heat exchange agent inlet 111. The vertical cross section of the heat exchange agent inlet 111 is specifically the cross section perpendicular to the flowing direction of the heat exchange agent in the heat exchange agent inlet 111. The relationship between A and B may be 0.5A ≤B≤1.2A.

(c) in FIG. 6 shows a horizontal cross-section on the outflow cavity 117 in communication with the heat exchange agent outlet 112, defining its area as C. (d) in FIG. 6 shows a cross-section of the heat exchange agent outlet 112, defining its area as D. The relationship between C and D can be 0.5C≤D≤1.2C.

Specifically, as shown in FIGS. 3 and 6, the cross section of the heat exchange agent inlet 111 and the heat exchange agent outlet 112 is a vertical cross section perpendicular to the orientation of the heat exchange agent inlet 111 and the heat exchange agent outlet 112. Alternatively, when the heat exchange agent inlet 111 and the heat exchange agent outlet 112 are, for example, in cylindrical shapes, the cross sections of the heat exchange agent inlet 111 and the heat exchange agent outlet 112 are cross sections perpendicular to the axial direction of the heat exchange agent inlet 111 and the heat exchange agent outlet 112.

Since the heat exchange agent inlet 111 and the heat exchange agent outlet 112 are located above the flow section, the heat exchange agent flows in the inflow cavity 116 and the outflow cavity 117 from top to bottom. As a result, the horizontal cross-sectional areas of the inflow cavity 116 and the outflow cavity 117 are a cross-sectional area of the heat exchange agent flowing in the inflow cavity 116 and the outflow cavity 117. The vertical cross-sectional areas of the heat exchange agent inlet 111 and the heat exchange agent outlet 112 are a cross-sectional area of the heat exchange agent flowing in the heat exchange agent inlet 111 and the heat exchange agent outlet 112.

If the relationship between A and B is B<0.5A, the size of the heat exchange agent inlet 111 will be too small, and the flow rate of the heat exchange agent will need to be increased in order to be able to meet the flow capacity demand when delivering heat exchange agent from the heat exchange agent inlet 111 to the inflow cavity 116. As a result, the performance requirements of the pump that drives the flowing of the heat exchange agent will increase, which will make the selection of the pump more difficult and increase the production cost of the vehicle.

If the relationship between C and D is D<0.5C, the size of the heat exchange agent outlet 112 will be too small and the pressure loss of the heat exchange agent will be too large when the heat exchange agent flows from the outflow cavity 117 to the heat exchange agent outlet 112, thus affecting the heat exchange efficiency.

If the relationship between A and B is B>1.2A, the size of the inflow cavity 116 will be too small, and the pressure loss of the heat exchange agent will be too large when the heat exchange agent flows from the heat exchange agent inlet 111 into the inlet cavity 116, thus affecting the heat exchange efficiency.

If the relationship between C and D is D>1.2C, the size of the heat exchange agent outlet 112 will be too large, thus increasing the amount of heat exchange agent, reducing the use efficiency of the heat exchange agent, increasing the weight and energy consumption of the vehicle, and affecting the driving range of the vehicle.

By setting the vertical cross-sectional area of the heat exchange agent inlet 111 to 0.5 times to 1.2 times the horizontal cross-sectional area of the inlet cavity 116 and the vertical cross-sectional area of the heat exchange agent outlet 112 to 0.5 times to 1.2 times the horizontal cross-sectional area of the outlet cavity 117, the space for the heat exchange agent to flow between the heat exchange agent inlet 111, the heat exchange agent outlet 112 and the inflow cavity 116 and the outflow cavity 117 will not change too much. This reduces the pressure loss of the heat exchange agent, avoids sudden changes in the flow rate of the heat exchange agent, and improves the heat exchange efficiency.

In some embodiments, the horizontal cross-sectional area A of the inflow cavity 116 and the vertical cross-sectional area B of the heat exchange agent inlet 111 can be set to A=B; and/or, the horizontal cross-sectional area C of the outflow cavity 117 and the vertical cross-sectional area D of the heat exchange agent outlet 112 can be set to C=D.

As a result, when the heat exchange agent flows between the heat exchange agent inlet 111, the heat exchange agent outlet 112, the inflow cavity 116, and the outflow cavity 117, the size of the space for the heat exchange agent to pass through is kept constant, thus further reducing the pressure loss of the heat exchange agent and improving the heat exchange efficiency.

As shown in FIG. 3, the heat exchange agent flow-paths 110 in this embodiment of the application also include a fluxion cavity 118 communicating with the other end of the first flow section 113 and the other end of the second flow section 114. The first flow section 113 and the second flow section 114 together form a U-shaped structure by being communicated with the fluxion cavity 118. Thus, the heat exchange agent in a plurality of branches 115 of the first flow section 113 can converge in the fluxion cavity 118 and be delivered by the fluxion cavity 118 to a plurality of branches 115 of the second flow section 114, thereby decreasing the pressure loss caused by splitting the heat exchange agent into at least two branches 115 when it enters the second flow section 114 from the first flow section 113, and thus improving the temperature regulation effect.

The fluxion cavity 118 in this embodiment of the application has an arced cross-sectional shape in the horizontal direction on the side away from the first flow section 113 and the second flow section 114. Specifically, the fluxion cavity 118 has an arced shape when viewed from above. Thus, by providing the fluxion cavity 118 with an arced shape, the heat exchange agent in the fluxion cavity 118 can be guided, thereby reducing the pressure loss of the heat exchange agent in the fluxion cavity 118.

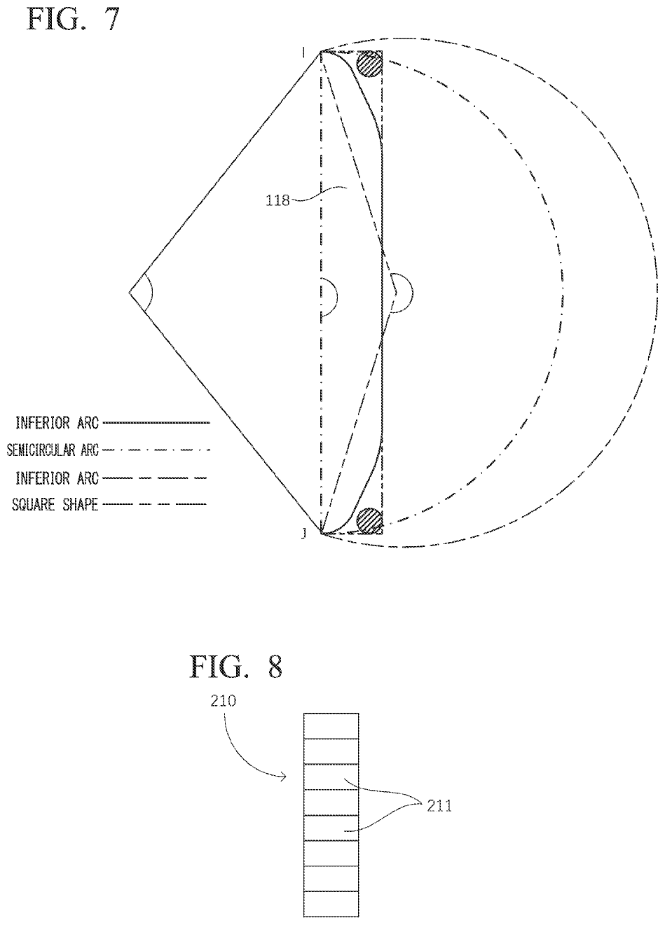

FIG. 7 shows the fluxion cavity 118 of the embodiment of the present application in comparison with other shapes of the fluxion cavity 118. As shown in FIGS. 3 and 7, the fluxion cavity 118 in the embodiment of the present application can be specifically provided with an inferior arc shape (i.e., the arc shape with the endpoints of I and J as shown in FIG. 7 corresponds to a central angle of less than 180°. Compared with the semi-circular arc fluxion cavity 118 and the major arc fluxion cavity 118 (i.e., the arc with the endpoints of I and J as shown in FIG. 7, which corresponds to a central angle greater than) 180°, the inferior arc fluxion cavity 118 occupies less space. As shown in FIG. 7, when the fluxion cavity 118 is square, the heat exchange agent will stagnate in the shaded position in FIG. 7, and the heat exchange agent in the shaded position will not participate in the temperature regulation of the battery 200. Therefore, the heat exchange agent will be wasted and the temperature regulation efficiency of the heat exchange agent will be reduced.

Thus, by providing the fluxion cavity 118 in an inferior arc, the volume of the fluxion cavity 118 can be reduced, which can enable a more compact structure of the housing 100. It can also prevent some of the heat exchange agent from stagnating in the fluxion cavity 118 and not being able to participate in the temperature regulation of the battery 200, thus improving the temperature regulation efficiency of the heat exchange agent.

As shown in FIGS. 3 and 7, the cross-sectional shape of the fluxion cavity 118 in the horizontal direction is a trapezoidal shape, and the bottom edge of the trapezoid (i.e., the edge of the side of the fluxion cavity 118 communicated with the first flow section 113 and the second flow section 114) is provided on the side close to the first flow section 113 and the second flow section 114, and the top edge of the trapezoid (the edge of the fluxion cavity 118 away from the side of the first flow section 113 and the second flow section 114) is away from the first flow section 113 and the second flow section 114. Since the length of the top edge of the trapezoid is smaller than the length of the bottom edge, the fluxion cavity 118 is provided in a trapezoid shape so that after the coolant in the first flow section 113 enters the fluxion cavity 118 from the bottom edge of the trapezoid near one side, the coolant can be guided by the both sides of the trapezoid and the top edge so that the coolant flows into the second flow section 114 from the bottom edge of the trapezoid near the other side. As a result, the pressure loss of coolant in the fluxion cavity 118 is reduced and some of the heat exchange agent can be prevented from stagnating in the fluxion cavity 118. Meanwhile, the trapezoidal structure also reduces the volume of the fluxion cavity 118, allowing for a more compact structure of the housing 100.

As shown in FIG. 3, the first flow section 113, the second flow section 114 and the fluxion cavity 118 in this embodiment of the present application form a U-shaped structure, i.e., the first flow section 113 and the second flow section 114 are connected via the fluxion cavity 118 to form a U shape. Accordingly, compared with an S-shaped flow-path, the number of turns of the heat exchange agent can be reduced, and thus the pressure loss of the heat exchange agent can be reduced, and the temperature regulation effect can be improved.

FIG. 8 is a schematic diagram of the structure of battery module 210 in FIG. 2. As shown in FIGS. 2 and 8, the battery 200 may include at least two battery modules 210, the battery modules 210 including at least two battery cores 211, specifically, as shown in FIGS. 2 and 8, the at least two battery cores 211 are provided with the width direction of the battery cores 211 in parallel to form the battery modules 210, and the length direction of the battery cores 211 is the same as the length direction of the housing 100.

As shown in FIG. 2, the branches 115 correspond to the battery cores 211 arranged in parallel, and the width direction of the branches 115 is the same as the width direction of the battery cores 211. If the width of the battery cores 211 is defined as X and the width of the branches 115 is defined as Y, preferably, the relationship between X and Y can be defined as 0.5X≤Y<X.

Accordingly, by setting the width of the branches 115 to be greater than or equal to half the width of the battery cores 211, it is possible to obtain a sufficient contact area between the branches 115 and the battery cores 211, and meanwhile ensure that there is enough heat exchange agent in the branches 115 so that the heat exchange with the battery cores 211 can be achieved quickly. Consequently, the heat exchange agent flow-paths 110 can meet the power requirement of heat exchange of battery 200. In addition, by setting the width of the branches 115 to be smaller than the width of the battery cores 211, it is possible to avoid the width of the branches 115 being too large to exceed the width of the battery cores 211, preventing some of the heat exchange agent in the branches 115 from participating in the heat exchange of the battery cores 211. Accordingly, it is possible to avoid adding excess weight and wasting the heat exchange power of the heat exchange agent flow-paths 110, and achieve light weight.

More preferably, the width X of the battery cores 211 and the width Y of the branches 115 can be set to 0.5X≤Y≤0.6X. Accordingly, the weight of the battery 200 can be further reduced while obtaining sufficient heat exchange power.

Since the space available for the battery pack 10 in the vehicle 1 is limited, the arrangement of battery modules 210 in the housing 100 is limited. For this reason, as shown in FIG. 2, the present application provides a preferred arrangement of the battery modules 210, i.e., after the battery modules 210 are mounted, the length direction of the battery cores 211 is consistent with the front-back direction of the vehicle 1. Compared with other arrangements of battery modules 210, such as making the length direction of the battery cores 211 consistent with the left-right direction of vehicle 1 after the battery modules 210 are mounted, or making the length direction of the battery cores 211 of some of the battery modules 210 consistent with the front-back direction of vehicle 1 and the length direction of the battery cores 211 of some of the battery modules 210 consistent with the left-right direction of vehicle 1 after the battery modules 210 are mounted, the maximum number of battery modules 210 can be mounted according to the arrangement of battery modules 210 in FIG. 2.

As shown in FIGS. 2 and 3, the first flow section 113, the second flow section 114 and their branches 115 extend along the length of the battery cores 211.

FIG. 9 shows a comparison of the extension of the heat exchange agent flow-paths 110 in the length direction and the width direction of the battery cores 211, in (a) of FIG. 9, the heat exchange agent flow-paths 110 extend in the length direction of the battery cores 211, and in (b) of FIG. 9, the heat exchange agent flow-paths 110 extend in the width direction of the battery cores 211. As shown in FIG. 9, since the length of the battery cores 211 is larger than the width thereof, the widths of the first flow section 113, the second flow section 114 and their branches 115 can be reduced by extending in the length direction of the battery cores 211 as shown in (a) of FIG. 9 according to the corresponding relationship between the branches 115 and the width/length of the battery cores 211; and the length required for the turn of the first flow section 113 and the second flow section 114, i.e., the length of the fluxion cavity 118, can also be reduced. Accordingly, the flow volume of the heat exchange agent in the heat exchange agent flow-paths 110 can be reduced and the weight of the battery can be reduced. In addition, the first flow section 113, the second flow section 114, and their branches 115 extend along the width of the battery cores 211 as shown in (b) of FIG. 9, requiring a larger bend arc and a larger bend distance when the heat exchange agent flow-paths 110 turn compared with the first flow section 113, the second flow section 114, and their branches 115 extending along the length of the battery cores 211 as shown in (a) of FIG. 9. If the bend arc of the heat exchange agent flow-paths 110 in (b) of FIG. 9 is decreased, the pressure loss of the heat exchange agent flowing in the first flow section 113 and the second flow section 114 is increased. Thus, the extension of the heat exchange agent flow-paths 110 in the length direction of the battery cores 211 can shorten the length of the heat exchange agent flow-paths 110, reduce the pressure loss of the heat exchange agent, and achieve light weight.

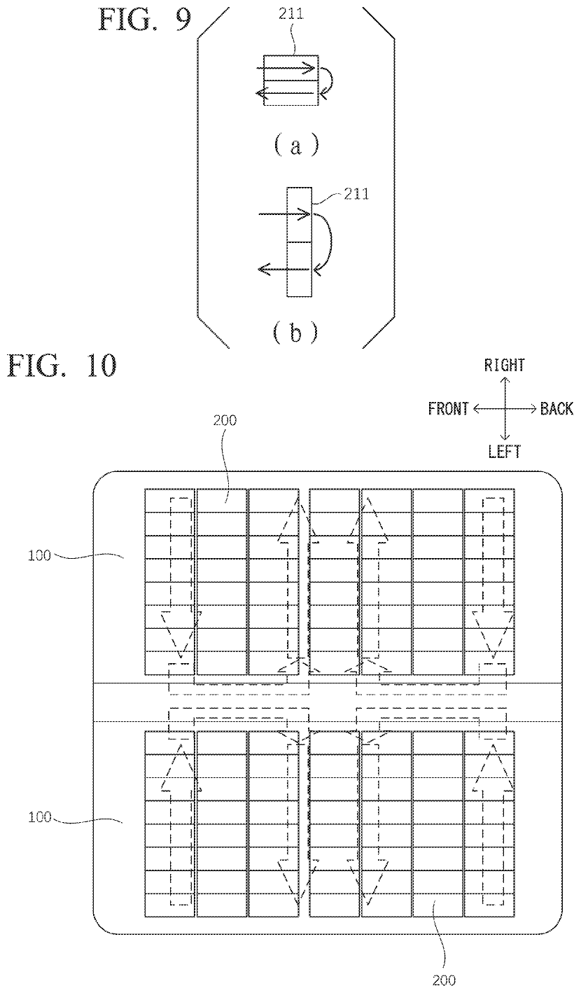

FIG. 10 is a schematic diagram of a comparative example of the flow direction of a heat exchange agent. The arrows in FIG. 10 show the flowing direction of the heat exchange agent when the first flow section 113 and the second flow section 114 extend in the width direction of the battery cores 211. By comparing FIG. 10 with FIG. 2, it can be seen that when the first flow section 113 and the second flow section 114 are arranged in the length direction of the battery cores 211, the amount of the first flow section 113 and the second flow section 114 is smaller than the amount of the first flow section 113 and the second flow section 114 arranged in the width direction of the battery cores 211. Thus, the length of the heat exchange agent flow-paths 110 and the number of turns can be reduced, thereby reducing the pressure loss of the heat exchange agent and improving the temperature regulation effect.

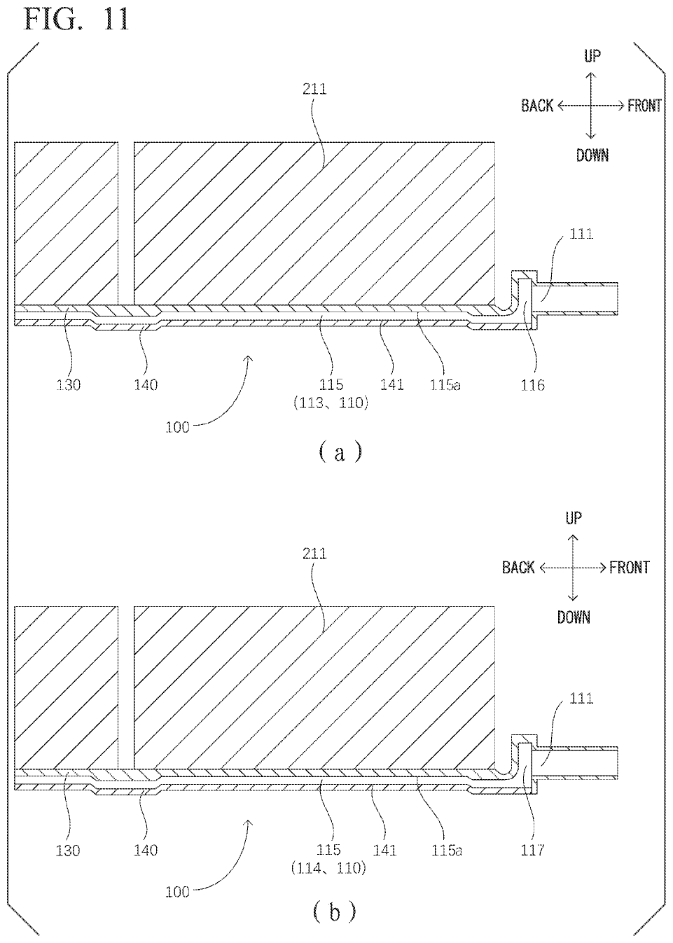

FIG. 11 shows a partial cross-section of the housing 100 in the vertical plane at the position of the heat exchange agent inlet 111 and the heat exchange agent outlet 112 in this embodiment of the application. (a) in FIG. 11 shows a partial cross-section of the housing 100 at the position of the heat exchange agent inlet 111 and (b) in FIG. 11 shows a partial cross-section of the housing 100 at the position of the heat exchange agent outlet 112. As shown in FIG. 11, the housing 100 may also include a lower housing 130 and a base plate 140 mounted on the lower housing 130, and the heat exchange agent flow-paths 110 are formed between the base plate 140 and the lower housing 130, thereby eliminating the need for a separate heat exchange agent tube and other components for the heat exchange agent to flow. Accordingly, the structure of the housing 100 can be simplified, and the weight of the housing 100 can be reduced to achieve light weight. Meanwhile, it is possible to reduce the number of parts of the housing 100, reduce the assembly steps and assembly time, and improve the assembly efficiency.

As shown in FIG. 11, the base plate 140 is provided with at least two bumps 141 convex toward the lower housing 130; and each of the bumps 141 corresponds to the position of one of the battery cores 211. Specifically, the bumps 141 may be made of sheet metal such that the bumps 141 are convex on the upper surface of the base plate 140 and concave on the lower surface of the base plate 140. The bumps 141 may be rectangular in shape corresponding to the shapes of the battery cores 211, with the surface areas of the upper surfaces of the bumps 141 being approximately equal to the surface areas of the lower surfaces of the battery cores 121. Accordingly, compared with the base plate of the same thickness in the form of a flat plate, the structural strength of the base plate 140 with the bumps 141 is stronger, and the strength of the base plate 140 at the positions corresponding to the battery cores 211 can be enhanced. In addition, in order to meet the strength requirement of the base plate 140, compared with increasing the thickness of the base plate 140, providing the bumps 141 on the base plate 140 can reduce the thickness and weight of the base plate 140, which in turn can reduce the weight of the housing 100 and achieve light weight.

In addition, when the upper surface of the base plate 140 needs to be machined using a milling cutter, only the upper surfaces of the bumps 141 need to be machined, i.e., only the positions corresponding to the battery cores 211 need to be machined, thereby reducing the workload of milling cutter machining and increasing the machining speed.

As shown in FIG. 11, concave parts 115a are also provided on one side of the lower housing 130 near the bottom plate 140 in the direction of recessing away from the bottom plate 140. The concave parts 115a are rectangular in shape and are located at positions corresponding to the above bumps 141, forming concave shapes upward. In this way, the thickness of the housing 130 at the corresponding positions of the battery cores can be smaller than the thickness of the housing 130 at other positions, thereby improving the heat exchange efficiency between the battery cores and the heat exchange agent in the branches 115. In addition, by providing the concave parts 115a, the height of the branches 115 can be kept constant while the branches 115 undulate up and down, so that the height of the branches 115 can be prevented from being affected by the bumps 141, which would result in an increase of the pressure loss. Meanwhile, as shown in FIG. 11, the undulation of the branches 115 is smaller, thus reducing the influence of the undulation of the branches 115 on the pressure loss of the heat exchange agent in the branches 115, thereby ensuring the heat exchange efficiency of the heat exchange agent.

In some embodiments, the lower housing 130 may also be connected to the battery 200 by a heat transfer adhesive. Accordingly, the heat transfer effect between the lower housing 130 and the battery 200 can be improved, which in turn improves the temperature regulation effect.

In some embodiments, the housing 100 may also include a heat insulation layer (not shown) provided on one side of the base plate 140 away from the lower housing 130. Accordingly, the influence of ambient temperature in the housing 100 and the battery 200 within the housing 100 can be reduced.

As shown in FIGS. 1 to 11, the above battery pack 10 may be provided in the bodywork 20 of the vehicle 1, with the first flow section 113, the second flow section 114 and its branches 115 in the battery pack 10 extending in the length direction of the vehicle 1.

From the above, it is possible to make the first flow section 113 and the second flow section 114 extend in the same direction as the length direction of the battery cores 211 when, for example, the length direction of the battery cores 211 in the battery pack 10 is the same as the length direction of the vehicle 1. Since the length of the battery cores 211 is larger than the width, under the condition that the first flow section 113 and the second flow section 114 have the same contact area with the battery cores 211, the first flow section 113 and the second flow section 114 extend in the length direction of the vehicle 1 in such a way that the length and width of the first flow section 113 and the second flow section 114 are smaller at the turning position when the first flow section 113 and the second flow section 114 extend in the length direction of the vehicle 1 as compared with the first flow section 113 and the second flow section 114 extending in the width direction of the vehicle 1. Accordingly, the capacity of the heat exchange agent in the turning position of the first flow section 113 and the second flow section 114 can be reduced, thereby reducing the weight of the battery pack 10 and the vehicle 1 and achieving light weight.

Possible embodiments of a battery pack for the vehicle of the present application have been described above in connection with FIGS. 2 to 11. In the following, the specific structure of an embodiment of the battery pack 10 of the vehicle 1 of the present application will be described in detail in conjunction with the accompanying drawings.

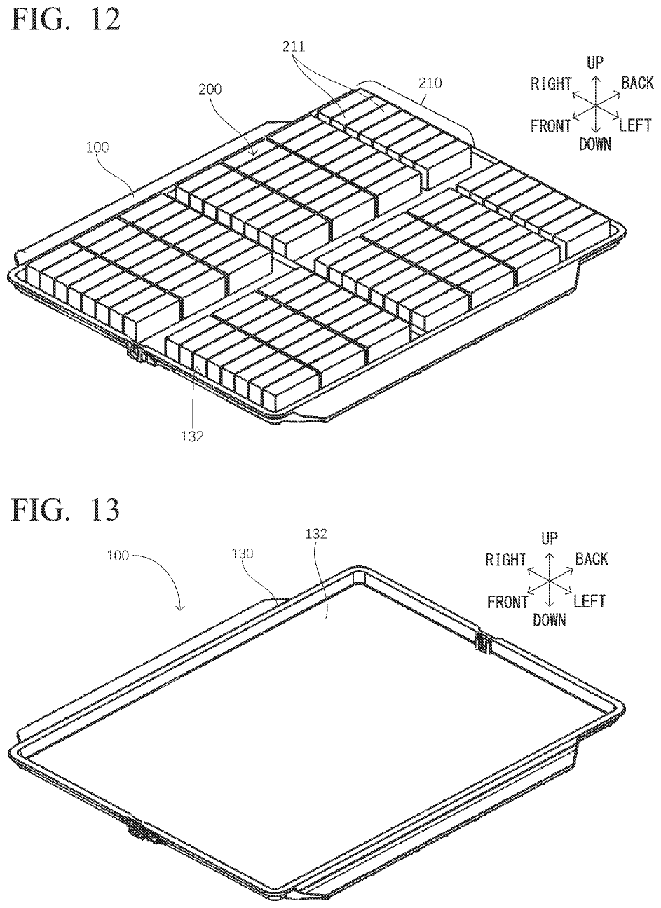

FIG. 12 is a schematic diagram of the three-dimensional structure of the battery pack in an embodiment of the present application. As shown in FIG. 12, the battery pack in this embodiment includes a housing 100 and a battery 200, with a mounting part 132 provided on the upper surface of the housing 100, and the battery 200 is mounted and fixed in the mounting part 132. The battery 200 includes 14 battery modules 210, and each battery module 210 includes 8 battery cores 211. As shown in FIG. 12, according to the size of the mounting space provided in the mounting section 132, the battery modules 210 are arranged in a 7×2 manner, i.e., 7 rows in the front-back direction of the housing 100 and 2 columns in the left-right direction of the housing 100. The battery cores 211 are rectangular in shape, the length direction of the battery cores 211 is the same as the front-back direction of the housing 100, and 8 battery cores 211 are arranged in parallel in the left-right direction of the housing 100.

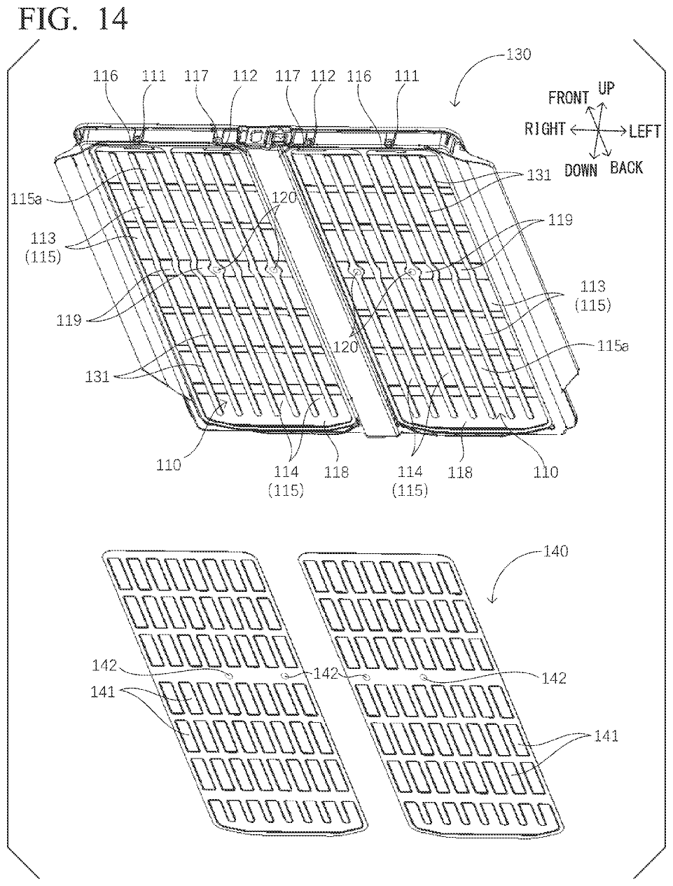

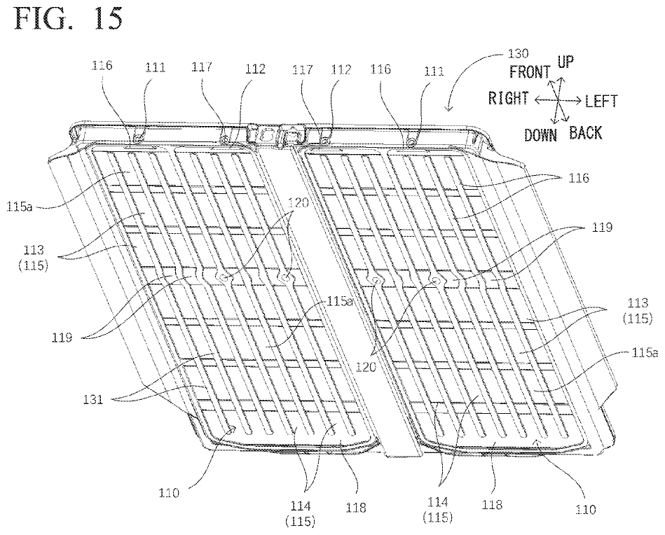

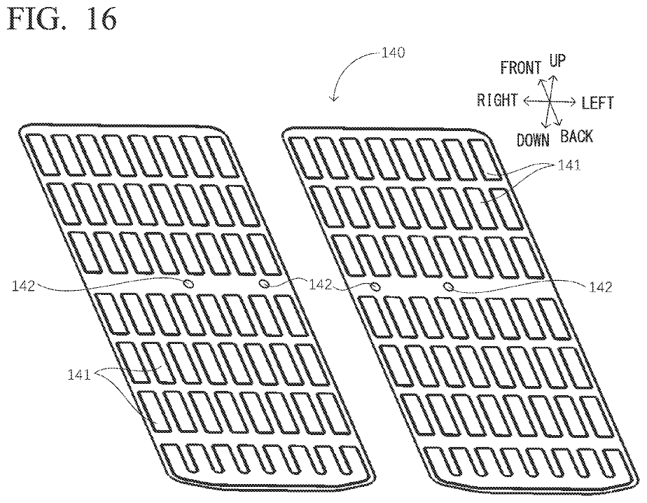

FIG. 13 is a schematic diagram of the structure of the housing 100 in FIG. 12; FIG. 14 is a disassembled schematic view of the housing 100 in FIG. 12; FIG. 15 is a schematic diagram of the structure of the lower housing 130 in FIG. 14; and FIG. 16 is a schematic diagram of the structure of the base plate 140 in FIG. 14. As shown in FIGS. 12 and 13, the housing 100 is a rectangular shaped shell-like component. The housing 100 may be mounted, for example, at the underside of the vehicle 1 or at other suitable positions of the vehicle 1, without limitation.

As shown in FIGS. 12 to 16, the housing 100 in this embodiment of the present invention includes a lower housing 130 and a base plate 140. The mounting part 132 is in a tray shape and is provided on the upper surface of the lower housing 130. The battery 200 may be provided on the mounting part 132 as shown in FIG. 12, and then the housing 100 is mounted in the vehicle 1, thereby enclosing the battery 200 in the vehicle 1 to provide effective protection for the battery 200. Alternatively, the housing 100 may also include an upper housing (not shown) that may be securely mounted on the upper portion of the lower housing 130, enclosing the battery 200 between the upper housing and the lower housing 130, thereby providing effective protection for the battery 200. A heat transfer adhesive may also be applied between the battery 200 and the lower housing 130, thereby improving the thermal conductivity between the battery 200 and the lower housing 130.

As shown in FIGS. 14 to 16, the base plate 140 is mounted on the lower surface of the lower housing 130, and heat exchange agent flow-paths 110 are formed between the base plate 140 and the lower housing 130. Two heat exchange agent flow-paths 110 are provided and arranged side by side in the width direction of the lower housing 130. The heat exchange agent flow-paths 110 include a first flow section 113 and a second flow section 114, the first flow section 113 and the second flow section 114 extend in parallel in the length direction of the lower housing 130, and the first flow section 113 is farther from the center of the battery 200 than the second flow section 114. The first flow section 113, the second flow section 114 and the fluxion cavity 118 form a U-shaped structure.

The lower housing 130 is also provided with a heat exchange agent inlet 111 and a heat exchange agent outlet 112, the heat exchange agent inlet 111 being farther from the center of the battery 200 than the heat exchange agent outlet 112. One end of the first flow section 113 is communicated with the heat exchange agent inlet 111, one end of the second flow section 114 is communicated with the heat exchange agent outlet 112, and the other end of the first flow section 113 is communicated with the other end of the second flow section 114.

Accordingly, the heat exchange agent can enter the first flow section 113 from the heat exchange agent inlet 111, then flow through the second flow section 114, and finally discharge from the heat exchange agent outlet 112. Since the heat exchange agent inlet 111 is farther from the center of the battery 200 than the heat exchange agent outlet 112, the first flow section 113 is farther from the center of the battery 200 than the second flow section 114. Consequently, the heat exchange agent is able to first exchange heat with the outer part of the battery 200 which is strongly influenced by the ambient temperature, and then exchange heat with the middle part of the battery 200 which is weakly influenced by the ambient temperature. Accordingly, the temperature difference between the different positions of the battery 200 can be reduced and the temperature regulation effect can be improved.

As shown in FIGS. 14 and 15, the lower surface of the lower housing 130 is provided with a plurality of protrusion bars 131 in protruding shapes in parallel, and the plurality of protrusion bars 131 divide each of the first flow section 113 and the second flow section 114 into 4 branches 115 in parallel. Specifically, the protrusion bars 131 are provided in the length direction of the battery cores 211, and after the base plate 140 is mounted on the lower housing 130, the protrusion bars 131 are set against the base plate 140 to divide the first flow section 113 and the second flow section 114 into 4 parallel-arranged branches 115, and the branches 115 extend in the length direction of the battery cores 211, with one branch 115 provided under each battery core 211. The branches 115 are not communicated with each other in the middle, and the branches 115 in the first flow section 113 are communicated with each other and the branches 115 in the second flow section 114 are communicated with each other at the ends of the first flow section 113 and the second flow section 114, respectively. Thus, each branch 115 can be provided in correspondence with a battery core 211 of the battery 200, so that the temperature regulation of the battery cores 211 can be precisely performed. Meanwhile, it is also possible to reduce the amount of heat exchange agent that is passed into the heat exchange agent flow-paths 110 by reducing the amount of heat exchange agent in the locations between adjacent battery cores that do not have a temperature regulation need.

As shown in FIGS. 14 and 15, the other end of the first flow section 113 and the other end of the second flow section 114 are communicated with the fluxion cavity 118 provided in an arc shape. Accordingly, the heat exchange agent in the fluxion cavity 118 can be guided, thus reducing the pressure loss of the heat exchange agent in the fluxion cavity 118. It is also possible to prevent the heat exchange agent from stagnating in the fluxion cavity 118, thus improving the use efficiency of the heat exchange agent.

Further, as shown in FIGS. 14 and 15, the fluxion cavity 118 is specifically provided in an inferior arc shape to reduce the space occupied by the fluxion cavity 118 and to enable a more compact structure of the housing 100.

As shown in FIGS. 14 and 15, the width of each branch 115 is the same, so that the pressure loss of the heat exchange agent between different branches 115 can be more uniform, and the pressure loss of the heat exchange agent in the heat exchange agent flow-paths 110 can be increased due to the excessive pressure loss of one branch 115. Meanwhile, by setting the widths of the branches 115 to be the same, it is also possible to make the flow rate of the heat exchange agent in each branch 115 more uniform, and thus the rate of temperature regulation of the battery 200 is more uniform, and the temperature regulation effect is improved.

Further, in order to reduce the size and make more efficient use of the mounting space, the two adjacent battery cores 211 are usually placed against one another. In addition, since the protrusion bars 131 also take up a certain space, the width of the branches 115 can be set smaller than the width of the battery cores 211 as shown in FIGS. 14 and 15.

Further, the smaller the width of the branches 115 is, the smaller the overlapping area between the battery cores 211 and the branches 115 in the vertical direction is, and accordingly, the lower the heat conduction efficiency between the battery cores 211 and the branches 115 is. Therefore, in order to ensure the efficiency of heat exchange between the battery cores 211 and the branches 115, the width of the branches 115 can be set to be greater than half of the width of the battery cores 211 as shown in FIGS. 14 and 15.

As shown in FIGS. 14, 15 and 16, the lower housing 130 in this embodiment of the present application is also provided with a first mounting position 120, the base plate 140 is provided with a second mounting position 142 at a position corresponding to the first mounting position 120, and the first mounting position 120 and the second mounting position 142 are mounting holes. After the base plate 140 is positioned on the lower surface of the lower housing 130, the base plate 140 and the lower housing 130 can be mounted on the bodywork 20 by using, for example, bolts and other parts to pass through the first mounting position 120 and the second mounting position 142.

As shown in FIGS. 14 and 15, the first mounting position 120 is positioned in the middle of the two branches 115 (i.e., on the protrusion bars 131), and is a mounting hole arranged to pass through the lower housing 130, the protrusion bars 131 form an arc-shaped turn at the positions corresponding to the left and right sides of the first mounting position 120, so that the branches 115 form deflecting bends 119 at the positions corresponding to the left and right sides of the first mounting position 120. The size of the arc-shaped turn on the protrusion bars 131 is set such that the further the branch 115 is from the first mounting position 120, the smaller the curvature of the deflecting bend 119 on the branch 115 is. Thus, it is possible to make the width of the branch 115 at the position of the deflecting bend 119 more uniform, which in turn makes the flow rate of the heat exchange agent more uniform between different branches 115 to improve the temperature regulation effect. Meanwhile, it is also possible to make the width of the branch 115 at the deflecting bend 119 not vary too much, thus reducing the pressure loss of the heat exchange agent in the branch 115.

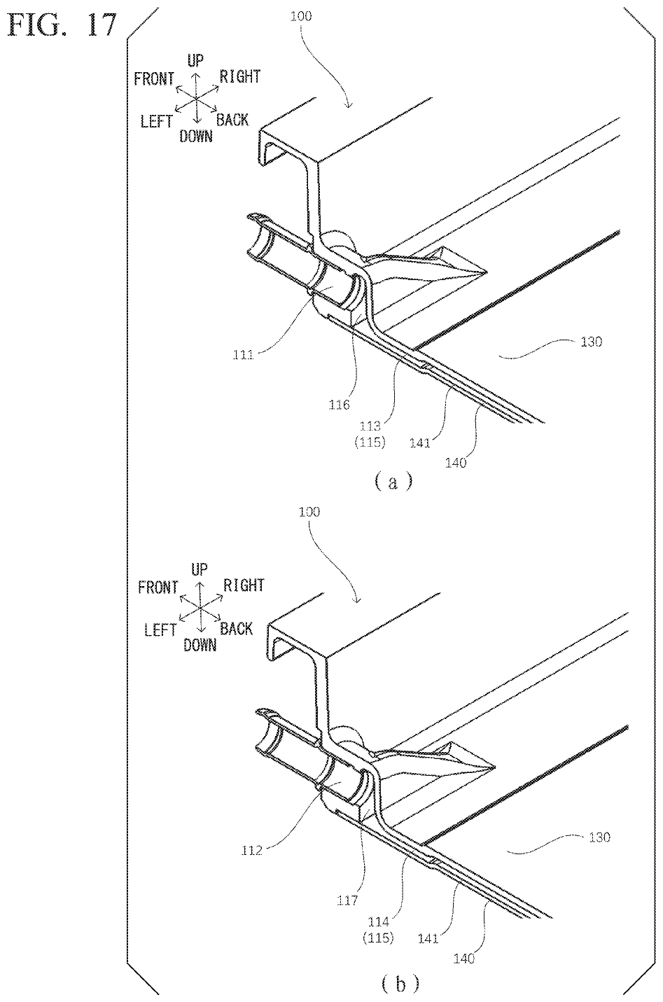

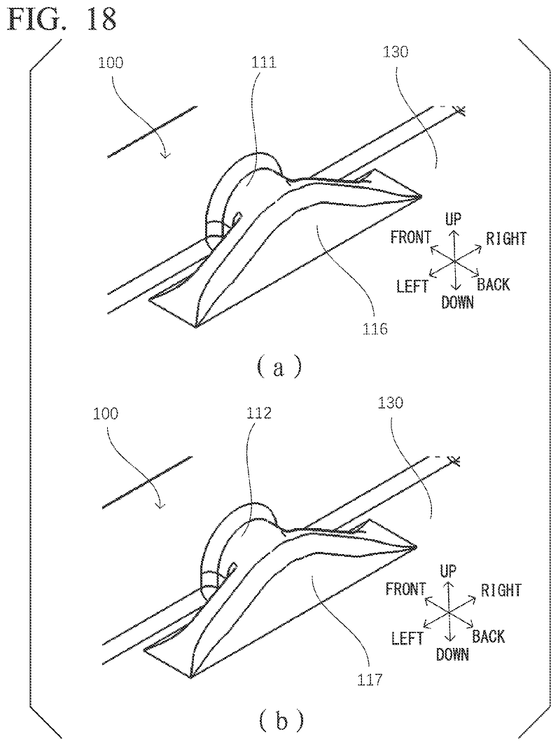

FIG. 17 is a radial sectional view of the thermal exchanger inlet 111 and the thermal exchanger outlet 112 in FIG. 13; and FIG. 18 is a schematic partial enlarged view of the inflow cavity 116 and outflow cavity 117 in FIG. 13. As shown in FIGS. 15, 17 and 18, in this embodiment of the present application, there is an inflow cavity 116 communicated between the heat exchange agent inlet 111 and the first flow section 113, and there is an outflow cavity 117 communicated between the heat exchange agent outlet 112 and the second flow section 114, with the heat exchange agent inlet 111 and the heat exchange agent outlet 112 being positioned further up than the first flow section 113 and the second flow section 114. Specifically, the lower end of the inflow cavity 116 is communicated with one end of the first flow section 113, and the lower end of the outflow cavity 117 is communicated with one end of the second flow section 114. The heat exchange agent inlet 111 is set horizontally and communicated with the inflow cavity 116 at the upper part of the inflow cavity 116, and the heat exchange agent outlet 112 is set horizontally and communicated with the outflow cavity 117 at the upper part of the outflow cavity 117.

Accordingly, after the battery pack 10 is mounted on the bottom of the vehicle 1, by making the heat exchange agent inlet 111 and the heat exchange agent outlet 112 higher than the first flow section 113 and the second flow section 114, the lower housing 130 can protect the heat exchange agent inlet 111 and the heat exchange agent outlet 112 from collision with objects appearing under the vehicle 1 during the driving of the vehicle 1, and the chance of leakage from the heat exchange agent inlet 111 and the heat exchange agent outlet 112 subjected to collision is reduced. As a result, the protective structure for the heat exchange agent inlet 111 and the heat exchange agent outlet 112 can be reduced, and the structural strength of the housing 100 can be improved.

As shown in FIGS. 17 and 18, the heat exchange agent inlet 111 and the heat exchange agent outlet 112 are in the form of a cylindrical tube and are set horizontally in the front-back direction. The inflow cavity 116 is generally trapezoidal in shape, and the cross-sectional area of the inflow cavity 116 in the horizontal direction gradually increases from top to bottom. Accordingly, the heat exchange agent flowing in the inflow cavity 116 can be guided so that the heat exchange agent flows in a diffuse manner in the inflow cavity 116 to each branch 115. Consequently, the pressure loss of the heat exchange agent in the inlet cavity 116 is reduced, and the flow of the heat exchange agent is facilitated to improve the temperature regulation effect.

As shown in FIGS. 17 and 18, the outflow cavity 117 is generally trapezoidal in shape, and the cross-sectional area of the outflow cavity 117 in the horizontal direction gradually decreases from bottom to top. Accordingly, the heat exchange agent flowing in the outflow cavity 117 can be guided so that the heat exchange agent gradually converges as it flows in the outflow cavity 117 toward the heat exchange agent outlet 112 so that the heat exchange agent is discharged from the heat exchange agent outlet 112. Consequently, the pressure loss of the heat exchange agent in the outflow cavity 116 can be reduced, the flow of the heat exchange agent can be facilitated, and the temperature regulation effect can be improved.

Further, the area of the horizontal cross-section on the inflow cavity 116 at the position communicated with the heat exchange agent inlet 111 is equal to the area of the vertical cross-section of the heat exchange agent inlet 111, and the area of the horizontal cross-section on the outlet cavity 117 at the position communicated with the heat exchange agent outlet 112 is equal to the area of the vertical cross-section of the heat exchange agent outlet 112. Accordingly, when the heat exchange agent flows between the heat exchange agent inlet 111, the heat exchange agent outlet 112 and the inflow cavity 116 and the outflow cavity 117, the space for the heat exchange agent to pass through is kept constant, thus further reducing the pressure loss of the heat exchange agent and improving the heat exchange efficiency.

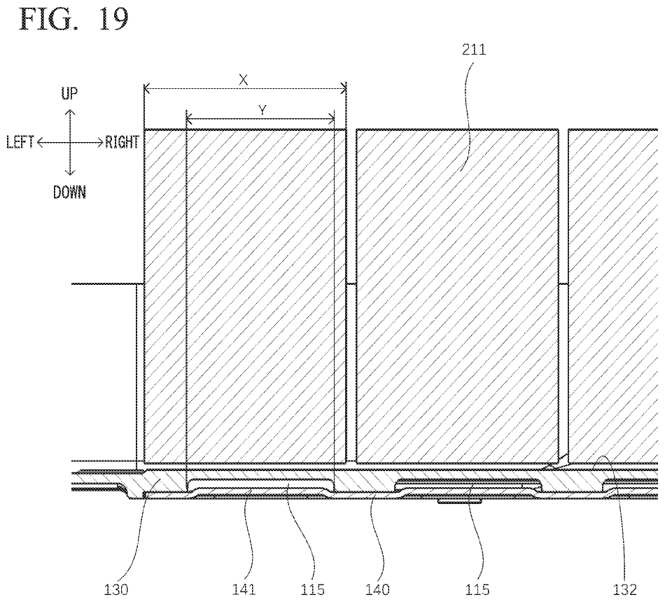

FIG. 19 is a partial cross-sectional enlarged view of the battery pack 10 in FIG. 12 at the corresponding position of the battery cores 211. As shown in FIGS. 14, 16 and 19, the base plate 140 in this embodiment of the present application is provided with upwardly protruding bumps 141, and the bumps 141 are provided on the side of the base plate 140 toward the lower housing 130 and are positioned at positions corresponding to the battery cores 211. The width of the bumps 141 is smaller than the width of the branches 115, and the bumps 141 are positioned inside the branches 115 after the base plate 140 is mounted on the lower housing 130. The bumps 141 on the base plate 140 may be made by means of metal plates, so that the lower surface of the base plate 140 is concave in the positions corresponding to the bumps 141. Thus, the structural strength of the base plate 140 can be improved at the positions corresponding to the battery cores 211. Meanwhile, the thickness and weight of the base plate 140 can be reduced while satisfying the strength requirements of the base plate 140, and consequently the weight of the housing 100 can be reduced to achieve light weight.

In addition, when the upper surface of the base plate 140 needs to be machined using a milling cutter, only the upper surfaces of the bumps 141 need to be machined, i.e., only the positions corresponding to the battery cores 211 need to be machined, thereby reducing the workload of milling cutter machining and increasing the machining speed.

As shown in FIGS. 14 and 15, concave parts 115a are provided on the branches 115, and the concave parts 115a are rectangular in shape and are positioned over the bumps 141, forming concave shapes upward. Thus, the thickness of the housing 130 at the corresponding positions of the battery cores is smaller than the thickness of the other positions of the housing 130, thereby improving the heat exchange efficiency between the battery cores and the heat exchange agent in the branches 115. In addition, by providing the concave parts 115a, it is possible to keep the height of the branches 115 constant and avoid the height of the branches being affected by the bumps 141. Therefore, the pressure loss of the branches 115 can be reduced and the heat exchange efficiency of the heat exchange agent can be improved.

As shown in FIG. 19, the width direction of the branches 115 in this embodiment of the present application is the same as the width direction of the battery cores 211. In the width direction of the battery cores 211, the branches 115 can be set in the middle of the battery cores 211, or can be set off to one side as shown in FIG. 17. If the width of the battery cores 211 is defined as X, and the width of the branches 115 is defined as Y, then 0.5X≤Y≤X.

Accordingly, by setting the width of the branches 115 to be greater than or equal to half of the width of the battery cores 211, sufficient contact area can be obtained between the branches 115 and the battery cores 211, and a sufficient amount of heat exchange agent can be present in the branches 115 to achieve rapid heat exchange with the battery cores 211. Consequently, the heat exchange agent flow-paths 110 can meet the heat exchange power requirements of the battery 200. In addition, by setting the width of the branches 115 to be smaller than the width of the battery cores 211, it is possible to avoid the width of the branches 115 being too large to exceed the width of the battery cores 211, which would cause some of the heat exchange agent in the branches 115 to be unable to participate in the heat exchange of the battery cores 211. Therefore, it is possible to avoid adding additional weight and wasting the heat exchange power of the heat exchange agent flow-paths 110, so as to achieve light weight.

Alternatively, the width X of the battery cores 211 and the width Y of the branches 115 can be set to 0.5X≤Y≤0.6X. Hence, the battery 200 can be made more lightweight while obtaining sufficient heat exchange power.

The above-mentioned battery pack 10 is mounted in the vehicle 1, and by setting the heat exchange agent inlet 111 farther away from the center of the battery 200 than the heat exchange agent outlet 112, and setting the first flow section 113 farther away from the center of battery 200 than the second flow section 114, after the heat exchange agent enters the first flow section 113 from the heat exchange agent inlet 111, it can first perform heat exchange with the outer part of the battery 200, which is strongly affected by the ambient temperature; and after the heat exchange agent flows to the second flow section 114, it can then perform heat exchange with the middle part of the battery 200, which is weakly affected by the ambient temperature. Hence, the temperature difference between the different positions of the battery 200 can be reduced and the temperature regulation effect can be improved.

After the battery pack 10 is set in the bodywork 20 of the vehicle 1, the first flow section 113, the second flow section 114 and the branches 115 in the battery pack 10 extend in the length direction of the vehicle 1.

From the above, it is possible to make the first flow section 113 and the second flow section 114 extend in the same direction as the length direction of the battery cores 211 when, for example, the length direction of the battery cores 211 in the battery pack 10 is the same as the length direction of the vehicle 1. The length dimension of the battery cores 211 is larger than the width dimension, and therefore, under the same condition that the first flow section 113 and the second flow section 114 have the same contact area with the battery cores 211, the first flow section 113 and the second flow section 114 extend in the length direction of the vehicle 1, compared to in the width direction of the vehicle 1, the length and width of the first flow section 113 and the second flow section 114 are smaller at the turning position when the first flow section 113 and the second flow section 114 extend in the length direction of the vehicle 1. Consequently, the capacity of the heat exchange agent in the turning position of the first flow section 113 and the second flow section 114 can be reduced, thereby reducing the weight of the battery pack 10 and the vehicle 1 and achieving light weight.

Combined with the above-mentioned accompanying drawings and the content of the description, in one embodiment of the battery pack 10 of the vehicle 1 of the present application, the battery pack 10 includes a housing 100 and a battery 200 provided in the housing 100.

The battery 200 includes at least two battery cores 211 arranged in parallel, the length direction of the battery cores 211 being in the same direction as the length of the vehicle 1.

The housing 100 is provided with heat exchange agent flow-paths 110 for regulating the temperature of the battery 200, and two heat exchange agent flow-paths 110 are provided, with the two heat exchange agent flow-paths 110 being symmetrically provided with respect to the center line L. The heat exchange agent flow-paths 110 include a heat exchange agent inlet 111 and a heat exchange agent outlet 112, with the heat exchange agent inlet 111 being farther from the center line L than the heat exchange agent outlet 112. The heat exchange agent flow-paths 110 also include a first flow section 113 and a second flow section 114 provided in a straight line. One end of the first flow section 113 is communicated with the heat exchange agent inlet 111, one end of the second flow section 114 is communicated with the heat exchange agent outlet 112, and the other end of the first flow section 113 is communicated with the other end of the second flow section 114 via the fluxion cavity 118, which together form a U-shaped structure. The first flow section 113 is farther from the centerline L than the second flow section 114.

From the above, after the heat exchange agent enters the first flow section 113 from the heat exchange agent inlet 111, it is able to first conduct heat exchange with the outer part of the battery 200 which is strongly affected by the ambient temperature; and after the heat exchange agent flows into the second flow section 114, it is then able to conduct heat exchange with the middle part of the battery 200 which is weakly affected by the ambient temperature. As a consequence, the temperature difference between the different positions of the battery 200 can be reduced and the temperature regulation effect can be improved.

The first flow section 113 and the second flow section 114 each include 4 branches 115, and each branch 115 is positioned on one side of a battery core 211. The width direction of the branches 115 is the same as the width direction of the battery cores 211, the width of the battery cores 211 is defined as X, and the width of the branches 115 is defined as Y. Preferably, the width X of the battery cores 211 and the width Y of the branches 115 can be set to 0.5X≤Y<X. More preferably, the width X of the battery cores 211 and the width Y of the branches 115 can also be set to 0.5X≤Y≤0.6 X.

From the above, by setting the width of the branches 115 to be more than or equal to half of the width of the battery cores 211, it is possible to obtain sufficient contact area between the branches 115 and the battery cores 211 as well as to ensure that there is enough heat exchange agent in the branches 115 so that the heat exchange with the battery cores 211 can be achieved quickly. Consequently, the heat exchange agent flow-paths 110 can meet the heat exchange power requirements of the battery 200. In addition, by setting the width of the branches 115 to be smaller than the width of the cores 211, it is possible to avoid the width of the branches 115 being too large and exceeding the width of the cores 211, which would result in some of the heat exchange agent in the branches 115 not being able to participate in the heat exchange of the battery cores 211. Consequently, it is possible to avoid adding additional weight and wasting the heat exchange power of the heat exchange agent flow-paths 110, and achieve light weight.

The heat exchange agent inlet 111 and the heat exchange agent outlet 112 are positioned over the first flow section 113 and the second flow section 114, thereby avoiding collisions between the heat exchange agent inlet 111 and the heat exchange agent outlet 112 and the connected pipes and other parts with the objects under the battery pack 10 to reduce the chance of fluid leakage due to collisions.

The heat exchange agent inlet 111 and the heat exchange agent outlet 112 are set in a circular tube in the horizontal direction, the inflow cavity 116 and the outflow cavity 117 are set in trapezoidal shapes, the cross-sectional area of the inflow cavity 116 in the horizontal direction gradually increases from top to bottom, and the cross-sectional area of the outflow cavity 117 in the horizontal direction gradually decreases from bottom to top. The horizontal cross-sectional area of the inflow cavity 116 in the center of the axis of the heat exchange agent inlet 111 is equal to the vertical cross-sectional area perpendicular to the center of the axis of the heat exchange agent inlet 111. The horizontal cross-sectional area of the outflow cavity 117 in the center of the axis of the heat exchange agent outlet 112 is equal to the vertical cross-sectional area perpendicular to the center of the axis of the heat exchange agent outlet 112. Consequently, when the heat exchange agent flows between the heat exchange agent inlet 111, the heat exchange agent outlet 112, the inflow cavity 116 and the outflow cavity 117, the space for the heat exchange agent to pass through remains constant, thus further reducing the pressure loss of the heat exchange agent and improving the heat exchange efficiency.

Note that the above is only a preferred embodiment of the present application and the technical principles used. One skilled in the art will understand that the present invention is not limited to the particular embodiments described herein, and that various obvious variations, readjustments and substitutions can be made by those skilled in the art without departing from the scope of protection of the present invention. Therefore, although the present application has been described in some detail with the above embodiments, the present invention is not limited to the above embodiments, but may include other equivalent embodiments without departing from the conception of the present invention, all of which fall within the scope of protection of the present invention.

What is claimed is:

1. A battery pack comprising:
a housing and a battery provided in the housing;
two or more heat exchange agent flow-paths for regulating the temperature of the battery in the housing;
the heat exchange agent flow-paths having a heat exchange agent inlet and a heat exchange agent outlet, the distance of the heat exchange agent inlet from the center of the battery pack being greater than the distance of the heat exchange agent outlet from the center of the battery pack;
the heat exchange agent flow-paths further comprising a first flow section and a second flow section; one end of the first flow section being in communication with the heat exchange agent inlet; one end of the second flow section being in communication with the heat exchange agent outlet; the other end of the first flow section being in communication with the other end of the second flow section; the distance between the first flow section and the center of the battery pack being greater than the distance between the second flow section and the center of the battery pack.

2. The battery pack according to claim 1, wherein, when the height of the first flow section is defined as h1, 2.1 mm h1 3.1 mm;
and/or, when the height of the second flow section is defined as h2, 2.1 mm≤h2 ≤3.1 mm.

3. The battery pack according to claim 1, wherein the first flow section and the second flow section each comprise at least two branches, the at least two branches being spaced apart and arranged in parallel.

4. The battery pack according to claim 3, wherein the branches in the first flow section are of the same width; and/or the branches in the second flow section are of the same width.

5. The battery pack according to claim 4, wherein the housing is provided with a mounting position between two branches; and the branches are provided with a deflecting bend that is arc-shaped to avoid the mounting position.

6. The battery pack according to claim 5, wherein the farther a branch is located from the mounting position, the smaller the curvature of the deflecting bend in the branch is.

7. The battery pack according to claim 1, wherein the heat exchange agent inlet is located further up than the first flow section; and/or the heat exchange agent outlet is located further up than the second flow section.

8. The battery pack according to claim 7, the heat exchange agent flow-paths further comprising:
an inflow cavity communicating one end of the first flow section with the heat exchange agent inlet, the inflow cavity having a cross-sectional area in the horizontal direction gradually increasing from top to bottom.

9. The battery pack according to claim 7, the heat exchange agent flow-paths further comprising:
an outflow cavity communicating one end of the second flow section with the heat exchange agent outlet, the outflow cavity having a cross-sectional area in the horizontal direction decreasing from bottom to top.

10. The battery pack according to claim 1, the heat exchange agent flow-paths further comprising: a fluxion cavity communicating the other end of the first flow section to the other end of the second flow section.

11. The battery pack according to claim 10, wherein,
the fluxion cavity is provided with an inferior arc cross-sectional shape in the horizontal direction on a side away from the first flow section and the second flow section;
and/or, the fluxion cavity is provided with a trapezoidal cross-sectional shape in the horizontal direction, with the bottom edge of the trapezoid provided on a side close to the first flow section and the second flow section, and the top edge of the trapezoid away from the first flow section and the second flow section.

12. The battery pack according to claim 10, wherein a U-shaped structure is formed by the first flow section, the second flow section and the fluxion cavity together.

13. The battery pack according to claim 1, wherein the housing comprises:
a lower housing;
a base plate mounted on the lower housing, with the heat exchange agent flow-paths formed between the base plate and the lower housing.

14. The battery pack according to claim 13, wherein the battery comprises at least two battery modules, the battery modules comprising at least two battery cores; the base plate is provided with at least two bumps protruding towards the lower housing; and the bumps are positioned in one-to-one correspondence with the battery cores.

15. The battery pack according to claim 14, wherein the first flow section and the second flow section both extend along the length of the battery cores.

16. The battery pack according to claim 14, wherein the lower housing is connected to the battery module by means of a heat transfer adhesive.

17. The battery pack according to claim 14, further comprising: a heat insulation layer provided on the side of the base plate away from the lower housing.

18. A vehicle comprising a bodywork provided with a battery pack according to claim 1.

19. The vehicle according to claim 18, wherein the first flow section and the second flow section both extend along the length of the vehicle.
